(19) United States
(12) Patent Application Publication
(10) Pub. No.: US 2008/0216941 A1
(43) Pub. Date: Sep. 11, 2008

(54) Tyre Manufacturing Process

(76) Inventors: Claudio Lacagnina, Milano (IT); Rodolfo Noto, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/579,605

(22) PCT Filed: May 10, 2004
(86) PCT No.: PCT/EP04/04967

§ 371 Date: Nov. 9, 2007

(51) Int. Cl. B29D 30/16; B29D 30/60; B29D 30/62; B60C 11/00

(52) U.S. Cl. 156/110.1; 264/319

(57) ABSTRACT

A process for manufacturing a tyre which has at least one structural element including at least one first portion made of a first crude elastomeric material, and at least one second portion made of the first crude elastomeric material, the second portion being axially spaced apart from the first portion. The process includes the steps of forming a crude tyre on a supporting device and moulding and curing the crude tyre, wherein the step of forming the crude tyre includes the step of providing the structural element. The step of providing the structural element includes: a) forming the first portion by winding at least one continuous elongate element made of the first crude elastomeric material by means of a roto-translational movement between the supporting device and an erogating device for supplying the continuous elongate element; b) starting to apply the continuous elongate element in a position axially spaced apart from the first portion while continuing supplying the continuous elongate element so as to form the second portion; and c) forming the second portion by winding the continuous elongate element made of the first crude elastomeric material by means a roto-translational movement between the supporting device and the erogating device.

The present invention relates to a process for manufacturing a tyre.

In particular, the present invention relates to a process for manufacturing a pneumatic tyre that comprises at least one structural element which is formed of at least two portions that are made of the same crude elastomeric material and are axially spaced apart from each other.

More in particular, the present invention relates to a process for manufacturing a tyre which is provided with a tread band comprising at least two portions that are made of the same crude elastomeric material and are axially spaced apart from each other.

Even more in particular, the present invention relates to a process for manufacturing an antistatic tyre which comprises a tread band having at least two portions axially spaced apart from each other and made of a first crude elastomeric material, and at least one further portion interposed between said at least two portions and made of a second crude elastomeric material which is different from the first crude elastomeric material, said first elastomeric material being electrically insulative while said second elastomeric material being electrically conductive.

Tyres which are provided with at least one structural element made of at least two different elastomeric materials are known in the art.

For instance, tread bands having distinct portions made of different elastomeric materials are generally provided to obtain tyres which can ensure a good compromise of different properties, such as low rolling resistance, good kilometric yield, comfort and road handling, while maintaining satisfactory traction features on dry, wet or snow-covered surfaces, also in the case high operating speeds (e g. higher than 200 km/h) and/or extreme driving conditions are involved.

Tread bands provided with at least two distinct portions made of different elastomeric materials are disclosed, for instance, in U.S. Pat. No. 4,319,620 and in EP-864,447 (in the name of the same Applicant).

In conventional tyre manufacturing processes, the tyre structural (i.e. constitutive) elements—e.g. the carcass plies, the belt layers, the tread band—are obtained by using semi-finished products, i.e. continuous sheets of elastomeric material—possibly in combination with reinforcing elements such as steel or textile cords—that are prepared separately and in large quantities previously to the tyre assembling operations.

According to said conventional processes, for each tyre component, the manufacturing process comprises the steps of winding a predetermined elastomeric sheet onto a building drum, cutting said sheet into a length approximately equal to the circumference of the drum, and joining the circumferentially opposite ends of said sheet length directly on the building drum.

More recently particular attention has been given to tyre production methods which eliminate, or at least reduce, the preliminary production of said semi-finished products. For example, the European patent EP-928,680—in the name of the same Applicant—discloses the manufacturing of a tyre by consecutively producing and assembling together on a toroidal support the tyre structural elements. In details, the tyre is manufactured by axially overlapping and/or radially superimposing turns of a strip-like element on the toroidal support, said strip-like element being a strip of an elastomeric material only, or a strip of elastomeric material embedding reinforcing elements thereinto (typically textile or metal cords), or a rubberized metal wire or cord.

According to said process, the toroidal support is moved, preferably by a robotized system, to sequentially reach a plurality of work stations, where, through automated sequences, different building steps of the tyre are carried out.

The manufacturing process further comprises the successive step of moulding the crude tyre, so as to confer to the latter a desired tread pattern, and the step of curing the crude tyre, so as to stabilize its geometrical conformation by curing the elastomeric materials forming the tyre itself. Such a tyre manufacturing process is described, for instance, in the European Patent EP-976,533 in the name of the same Applicant.

According to the tyre manufacturing process disclosed in the European Patent EP-928,680 mentioned above, tyres with different sizes and/or different internal structures (e.g. different number of carcass plies or belt layers, presence of elastomeric or reinforced inserts in specific regions of the tyre structure) can be manufactured simultaneously in the same plant thanks to a suitable electronic control of the work stations—which operate consecutively according to a predetermined sequence —and to the great production flexibility of the same.

According to said more recent processes mentioned above, some tyre structural elements—such as, for instance, the tread band or the liner—are generally obtained by winding, on the tyre being formed or directly on a supporting device, a continuous elongate element made of crude elastomeric material so as to form a plurality of coils axially arranged side-by-side and/or radially superimposed.

In the case a tyre structural element comprises at least two distinct portions made of the same elastomeric material and axially spaced apart from each other, according to the known tyre manufacturing processes the step of providing said tyre structural element requires that the provision of a continuous elongate element and the winding thereof are interrupted when a first portion of the tyre structural element is completed and successively restarted in correspondence of an axially spaced apart position where a second portion of the tyre structural element has to be provided.

In particular, in the case a tyre structural element comprises at least a first portion and a second portion, made of a first crude elastomeric material and axially spaced apart from each other, and a third portion, made of a second crude elastomeric material different from said first elastomeric material and interposed between said first portion and said second portion, according to the known tyre manufacturing processes the step of providing said tyre structural element requires that a continuous elongate element made of said first elastomeric material is erogated by a first erogating device, e.g. an extruder, and wound to obtain the first portion of the tyre structural element by forming a plurality of coils axially arranged side-by-side and/or radially superposed. When the first portion is completed, the erogation of the continuous elongate element made of said first elastomeric material and the winding thereof are interrupted and successively restarted in a position axially spaced apart from said first portion to obtain the second portion of the tyre structural element. Successively, a continuous elongate element made of said second elastomeric material is erogated by a second erogating device and is wound in the space defined between the first portion and the second portion so as to form the third portion for completing the tyre structural element.

Alternatively, the formation of the third portion of the tyre structural element can be carried out before the formation of the first and second portions thereof. According to said alternative process, a continuous elongate element made of the second elastomeric material is erogated and wound to form the third portion of the tyre structural element. Successively, the continuous elongate element made of the first crude elastomeric material is erogated and wound to form the first portion of the tyre structural element. When the first portion is completed, the erogation and winding of the continuous elongate element made of the first crude elastomeric material is stopped to allow a relative movement between the tyre and the erogating device so as to place the latter in correspondence of the position in which the second portion has to be provided. Thus, the erogation and winding of the continuous elongate element made of the first crude elastomeric material are restarted to form the second portion axially spaced apart from the first portion, the third portion being interposed between said first and second portions.

Such a process is described, for instance, in document EP-1,175,992 which discloses a method for producing a tyre tread provided with an electrically conductive layer which is formed by using an uncured high electrically conductive rubber ribbon. Said ribbon is wound on a circumference of the tyre as at least an outermost layer at a given height in a radial direction under the rotation of the tyre, the uncured tread rubber being wound on the circumference of the tyre before or after the winding of said ribbon.

The Applicant has observed that the processes mentioned above remarkably increase the manufacturing time of the tyre structural element and consequently the overall manufacturing time of the tyre comprising said structural element.

In detail, the Applicant has observed that the manufacturing time remarkably increases whenever the manufacturing of the tyre structural element is interrupted and successively restarted to obtain the distinct portions which form the tyre structural element.

The Applicant has noted that the increase in the manufacturing time of the tyre structural element is due to at least two different reasons.

Firstly, every time the erogation of the continuous elongate element is interrupted, at least one relative movement between the supporting device—on which the tyre is being formed—and the erogating device—which provides the continuous elongate element—is required in order to move away the erogating device from the supporting device and then to approach the erogating device to the position in which the winding of the tyre structural element has to be restarted. This increases the overall manufacturing of the tyre.

Secondly, the erogating device is subjected to transient states every time the erogation is started or interrupted. In fact, the pressure within the erogating device requires to be gradually increased or decreased in order to obtain a predetermined and constant erogation speed or to reduce the latter to zero. As a consequence, a certain period of time is needed to complete the transient state, which mainly depends on the flow rate and the viscosity of the elastomeric material which is used, as well as on the output cross section of the erogating device (i.e. on the transverse dimensions of the elongate element).

Therefore, according to the known processes mentioned above, at least two additional transient states are required during the deposition steps of the first and second portions made of the same elastomeric material.

This means that the overall manufacturing time of the tyre structural element increases since the steps mentioned above are time-consuming and non-productive.

Therefore, the Applicant has perceived that a remarkable increase of the production rate of a tyre manufacturing plant, can be obtained by reducing the manufacturing time of a tyre structural element which comprises at least two distinct portions axially spaced apart from each other and made of the same elastomeric material.

In particular, the Applicant has perceived that the manufacturing time of such a tyre structural element can be remarkably decreased by continuously forming said tyre structural element without interrupting and restarting the erogation and the winding of the continuous elongate element which is used to obtain said at least two distinct portions.

More in particular, the Applicant has perceived that the formation of said at least two distinct portions by continuously erogating and winding the continuous elongate element while providing a relative roto-translational movement between the erogating device and the crude tyre allows to eliminate some transient states of the erogating device as well as some relative movements between the latter and the supporting device on which the tyre is formed so as to remarkably decrease the overall manufacturing time of the tyre.

In a process for manufacturing a tyre, the latter comprising at least one structural element which is made of a crude elastomeric material and includes at least one first portion and one second portion which are axially spaced apart from each other, the Applicant has found that said structural element can be continuously obtained by forming the at least one first portion, by winding a continuous elongate element—made of said first crude elastomeric material—by means of a roto-translational movement between the tyre and the erogating device supplying said elongate element, and by successively forming the at least one second portion by applying the continuous elongate element in a position axially spaced apart from said first portion while continuing supplying said continuous elongate element.

In details, the process for manufacturing a tyre comprises: forming a crude tyre on a supporting device, moulding and curing said crude tyre, wherein the step of forming the crude tyre comprises providing at least one structural element of the tyre including:
at least one first portion made from a first crude elastomeric material, and
at least one second portion made from said first crude elastomeric material, the at least one second portion being axially spaced apart from the at least one first portion,

said step of providing the at least one structural element comprising:
forming the at least one first portion by winding at least one continuous elongate element made of said first crude elastomeric material by means of a roto-translational movement between the supporting device and at least one erogating device for supplying the at least one continuous elongate element;
starting to apply the continuous elongate element in a position axially spaced apart from the at least one first portion while continuing supplying the at least one continuous elongate element so as to form the at least one second portion, and
forming the at least one second portion by winding said at least one continuous elongate element made of said first crude elastomeric material by means a roto-translational movement between the supporting device and the at least one erogating device.

Preferably, when the first portion of the tyre structural element is completed, the relative roto-translational movement between the supporting device and the erogating device is incremented while continuing supplying the continuous elongate element.

More preferably, since the roto-translational movement results from a relative rotational speed combined with a relative translational speed, at the end of the step of forming the first portion of the tyre structural element, the relative rotational speed is increased to provide the continuously erogated elongate element in correspondence of the position in which the deposition of the second portion has to be started.

Even more preferably, the rotational speed of the supporting device is increased. An increase in the rotational speed of the supporting device corresponds to an increase in the translational speed thereof so that the supporting device is rapidly moved with respect to the erogating device in order to locate the latter in the predetermined position in which the second portion of the tyre structural element has to be provided.

Preferably, the rotational speed of the supporting device is incremented while maintaining constant the erogation speed of the continuous elongate element supplied by the erogating device. Therefore, while passing from the position in which the first portion of the tyre structural element is completed to the position in which the second portion thereof is started, the elongate element is subjected to a stretching action which reduces the cross-section area thereof, in particular the width of said elongate element.

According to the present invention, the step of winding a continuous elongate element comprises the step of forming a plurality of coils axially arranged side-by-side and/or radially superposed to form a portion of said tyre structural element.

In the case the tyre structural element comprises at least one third portion which is made of a second crude elastomeric material which is different from the first elastomeric material of the at least two portions and is interposed between said first and second portions, the manufacturing process of the present invention further comprises the step of forming the third portion by winding at least one further continuous elongate element which is made of said second crude elastomeric material. Said further step is carried out by means of a roto-translational movement between the supporting device and at least one further erogating device which is provided for supplying said further continuous elongate element.

Preferably, the step of forming said third portion is carried out before the step of forming the first portion.

Alternatively, the step of forming said third portion is carried out after the steps of forming the first and second portions of the tyre structural element.

According to an embodiment of the present invention, the tyre structural element which can be obtained with the process of the present invention is the tyre tread band, the latter comprising a first portion and a second portion that are spaced apart from each other and are made of the same elastomeric material.

Preferably, the tread band further comprises a third portion which is interposed between said first and second portions and is made of a second elastomeric material which is different from the first elastomeric material of the first and second portions.

The process of the present invention is particularly suitable for manufacturing antistatic tyres, i.e. tyres which are able to discharge to the ground the electrostatic charges accumulated on the vehicle body during running thereof.

In the case the electrostatic charges are not discharged, they give rise to a plurality of drawbacks.

For instance, at the moment the vehicle body is touched by a person or an object, thereby creating a conductive connection between the vehicle body and the ground, the electrostatic energy previously stored is completely and suddenly discharged producing an electric discharge (of high potential—e.g. in the order of 25 KV—but of very low intensity—e.g. in the order of mA).

Furthermore, said electrostatic discharges constitute a great danger during the fuel supply operations since the discharge can take place between the motor-vehicle bodywork and the fuel delivery gun.

Moreover, said electrostatic charges can also give rise to frequent electric discharges between different parts of the vehicle, causing unacceptable operating noise in the radio sets and/or any other electric or electronic apparatus installed on board of the vehicle.

It is known that tyre tread bands which are made of an elastomeric blend comprising high amounts of silica and low carbon black content are electrically insulative, thereby not allowing the electrostatic charges to be transferred from the vehicle body to the ground through the tyre. The low resistivity of the tread band is usually overcome by introducing at least one electrically conductive insert which is arranged in the tread band thickness and preferably extends over the whole circumferential extension of the tyre. The conductive insert becomes part of a conductive path which electrically connects the vehicle body—through the rim—to the ground by passing through the tyre structure. Such a technical solution is disclosed, for instance, in document EP-658,452, in the name of the same Applicant.

According to said embodiment, the first elastomeric material of the first and second portions is electrically insulative, while the third portion of the tread band (i.e. the above mentioned insert) is made of the second elastomeric material which is electrically conductive.

Preferably, the second elastomeric material has an electric resistivity not exceeding 10³ Kohm*m.

According to a further embodiment, the tyre structural element which can be obtained with the process of the present invention is the liner, i.e. the elastomeric layer which is suitable for ensuring the retention of the tyre inflating fluid.

According to a further embodiment, the tyre structural element which can be obtained with the process of the present invention is any elastomeric insert which can be provided to the tyre structure.

For instance, the tyre manufacturing process according to the present invention can comprise the step of forming the elastomeric inserts which are usually provided to truck tyres under the belt structure, at the axially outer edges thereof. Said inserts are used to support and protect the axial edges of the belt layers thereby increasing the tyre tear resistance in correspondence of the belt edges.

According to a further embodiment, the tyre manufacturing process according to the present invention can comprise the step of forming the elastomeric inserts which are usually provided to truck tyres at the axially outer edges of the belt structure, between said axial outer edges and the tread band. Generally these inserts, which are part of the tread band but are made of an elastomeric material (a low hysteresis material) which is different from the elastomeric material of the tread band, are used to decrease the thermal state of the tread band in correspondence of the axial outer edges of the belt structure.

According to a further embodiment, the tyre manufacturing process according to the present invention can comprise the step of forming the elastomeric inserts which are provided to a tyre, preferably a car tyre, to confer thereto a self-supporting property when the tyre is run under deflated conditions. Said inserts are generally provided between the liner and the carcass ply so as to increase the flexural rigidity of the sidewall when the radial force exerted by the pressurized inflation air remarkably decreases due to a puncture of the tyre. Said inserts are disclosed, for instance, in documents EP-475,258 and EP-542,252, in the name of the same Applicant.

Preferably, the process of the present invention further comprises the step of providing a crude carcass structure by assembling at least one carcass ply with at least two annular reinforcing structures.

Preferably, the process of the present invention further comprises the step of providing a belt structure in a position radially external to said carcass structure.

Additional features and advantages of the invention will be better apparent from the following description of some preferred embodiments of a tyre manufacturing process according to the present invention, which description is made, by way of non-limiting example, with reference to the attached drawings, wherein:

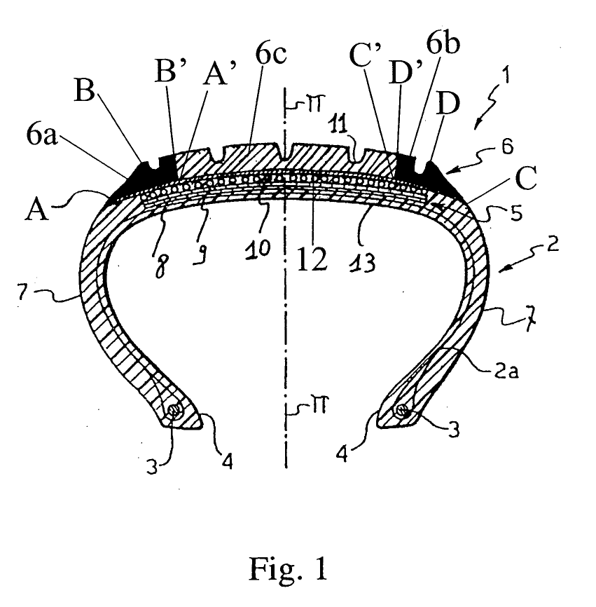

FIG. 1 is a partial cross-section view of a pneumatic tyre obtained with a process according to the present invention;

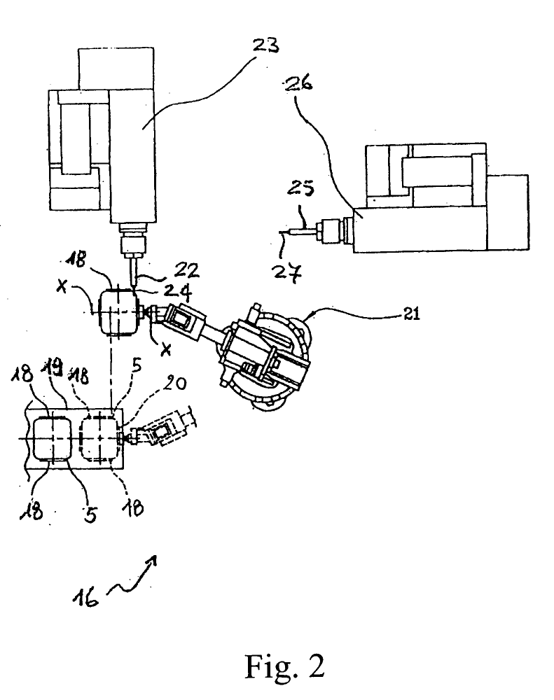

FIG. 2 is a partial schematic plan view of a robotized work station for making a tread band of a pneumatic tyre in accordance with a process of the present invention;

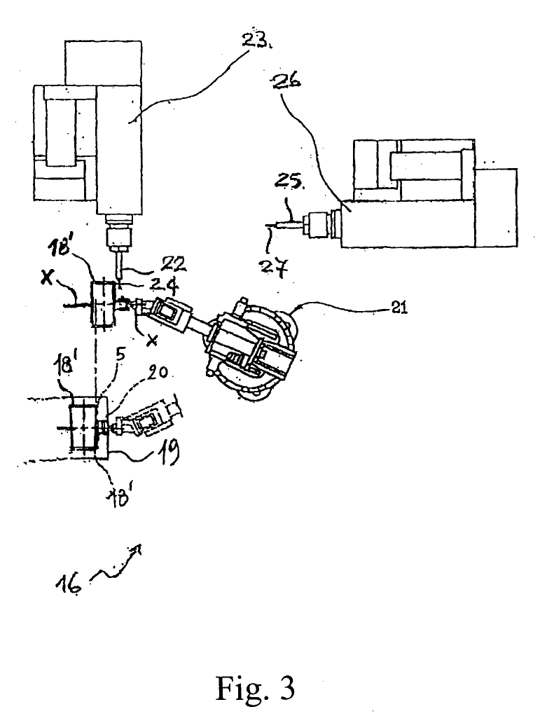

FIG. 3 is a schematic plan view of a robotized work station for making a tread band of a pneumatic tyre in accordance with a further embodiment of the process shown in FIG. 2;

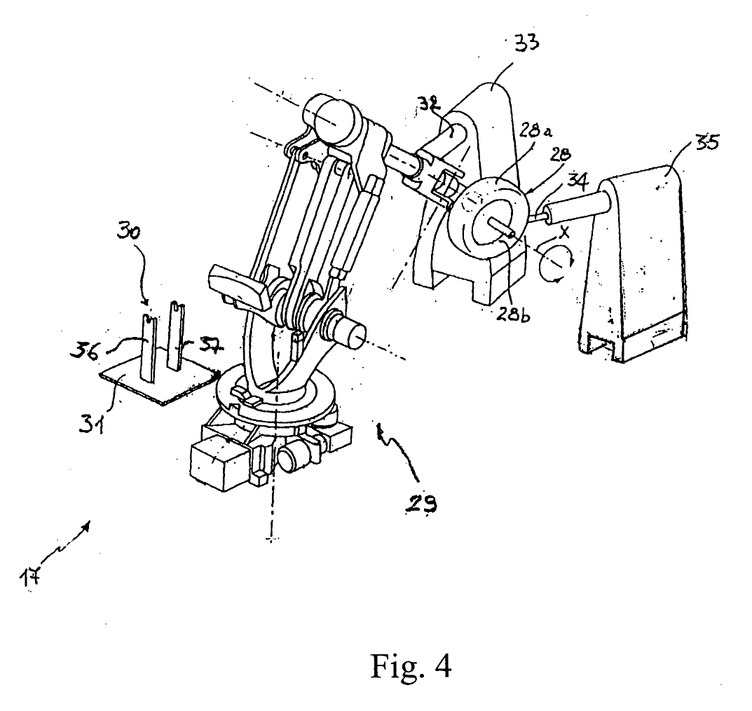

FIG. 4 is a schematic perspective view of a robotized work station for making a tread band of a pneumatic tyre in accordance with a process of the present invention which makes use of a substantially rigid toroidal support;

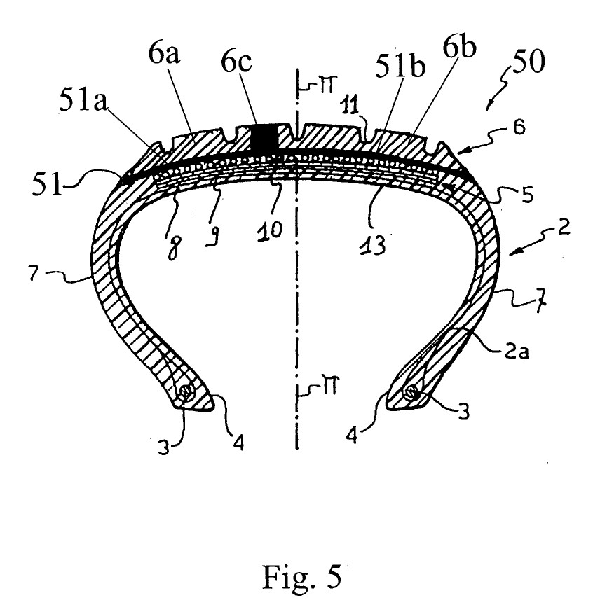

FIG. 5 is a partial cross-section view of an antistatic pneumatic tyre obtained with a process according to the present invention, and

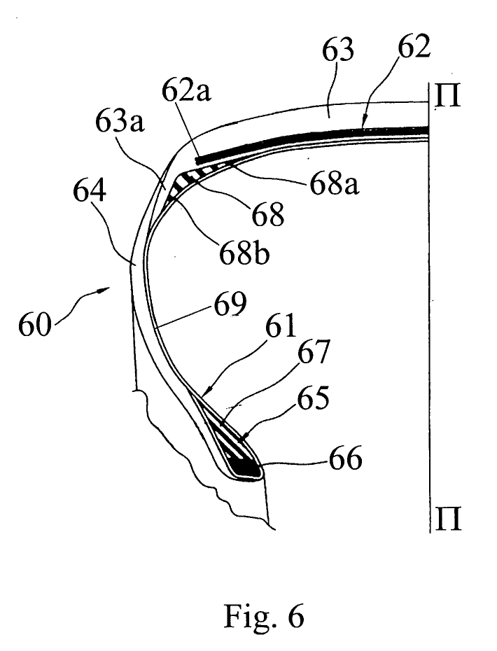

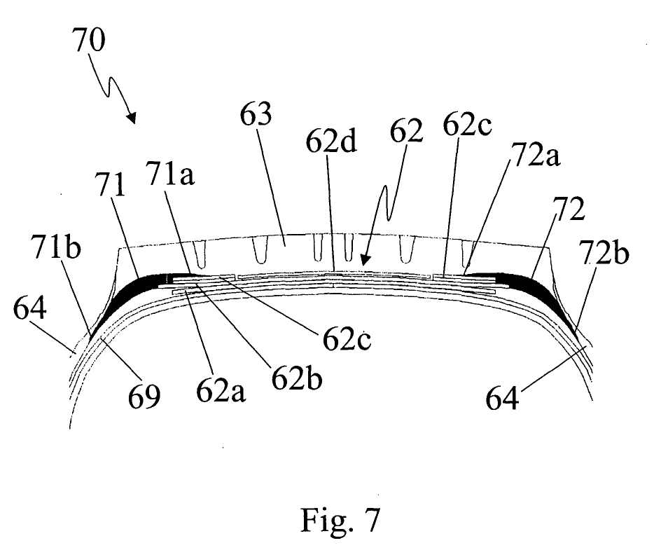

FIGS. 6 and 7 are partial cross-section views of two pneumatic tyres obtained with a process according to the present invention.

FIG. 1 shows a partial cross-section view of a tyre 1 comprising a carcass structure 2 obtained with a conventional tyre manufacturing process. The carcass structure 2 comprises one carcass ply 2a, the opposite side edges of which are externally folded up around respective annular reinforcing structures 3, usually known as bead cores.

Alternatively (said embodiment being not shown), each carcass ply 2a has its ends integrally associated with the respective bead cores 3, as disclosed in the European patent EP-928,680 mentioned above.

The bead core 3 is enclosed in a bead 4 defined along an inner circumferential edge of the pneumatic tyre 1 and at which the pneumatic tyre engages on a rim (not shown) forming part of the wheel of a vehicle.

The tyre 1 comprises a pair of sidewalls 7 which are located in axially opposite positions with respect to the carcass structure 2.

The tyre 1 also comprises a tread band 6 in a position radially external to the carcass structure 2. The tread band 6 shown in FIG. 1 comprises three distinct portions 6a, 6b and 6c. In details, the portions 6a, 6b are made of a first elastomeric material and are axially spaced apart from each other. The portion 6c is interposed between said two first and second portions 6a, 6b and is made of a second elastomeric material which is different from the first elastomeric material.

Furthermore, the tread band 6 is provided with a raised pattern which is formed for the tyre ground contact at the end of the curing and moulding steps of the tyre manufacturing process. In FIG. 1 the tread band 6 is provided with a plurality of grooves 11 which define a plurality of ribs and blocks of the tyre tread pattern.

The tyre 1 further comprises a reinforcing structure 5, usually known as belt structure, which is positioned between the carcass structure 2 and the tread band 6. Preferably, the belt structure 5 includes at least two radially superposed layers 8, 9 of rubberised fabric provided with reinforcing cords, usually of metal material, disposed parallel to each other in each layer and in crossed relationship with the cords of the adjacent layer, preferably symmetrically disposed with respect to the equatorial plane π-π of the tyre. Preferably, the belt structure 5 further comprises, at a radially external position of said belt layers 8, 9, at least one further layer 10 of textile or metallic cords substantially circumferentially disposed, said cords being spirally and coaxially wound at a radially outer position with respect to the belt layers 8, 9.

In the embodiment shown in FIG. 1, the tyre 1 is further provided with a layer 12 of a suitable elastomeric material which is interposed between the tread band 6 and the belt structure 5. Preferably, the layer 12 has the function of improving the adhesion between the tread band 6 and the belt structure 5.

Finally, in tyres of the tubeless type, i.e. devoid of an air inner bladder, a radially internal elastomeric layer 13, i.e. the liner, is present which has imperviousness features to ensure the tyre air-tightness.

With reference to FIGS. 2, 3 and 4, respective work stations are described, generally indicated with reference sign 16 in FIGS. 2 and 3 and with reference sign 17 in FIG. 4, which are provided for manufacturing the tread band 6 of a tyre in accordance with the manufacturing process of the present invention.

In the embodiment illustrated in FIG. 2, a robotized work station 16 is associated to a conventional manufacturing plant for the production of pneumatic tyres, said conventional plant being not shown in details as known per se.

In such a plant, apparatuses—known per se and not shown—are provided for manufacturing the carcass structure 2 and the annular reinforcing structure 3 associated thereto on a supporting device capable to assume a substantially toroidal configuration, such as for example a manufacturing drum 18, as well as for subsequently forming the belt structure 5 in a radially outer position with respect to the carcass structure 2.

The work station 16 comprises a robotized arm 21, preferably of the anthropomorphic type with seven axes, intended to pick up each drum 18 supporting the carcass structure 2, the annular reinforcing structure 3 and the belt structure 5 from a pick up position 20, defined at the end of a conveyor belt 19 or any other suitable transporting means, to a delivery position of the tread band 6.

In FIG. 2, the work station 16 further comprises a delivery member 22 of an extruder 23 which provides for a continuous elongate element 24—having a suitable size in cross-section—which is suitable for manufacturing the portions 6a, 6b of the tyre tread band 6.

With reference to the work station 16 and to FIG. 2, the tyre manufacturing process comprises a plurality of preliminary steps which are carried out upstream of the work station 16. In particular, the carcass structure 2 comprising the annular reinforcing structure 3 and the belt structure 5 are manufactured and shaped on the drum 18 which assumes and then determines a substantially toroidal shape of the pneumatic tyre under construction. Said drum 18 is then transported by the conveyor belt 19 to the pick up position 20.

In a subsequent step, the robotized arm 21 positions the drum 18 in the delivery position defined at the delivery member 22 of the elongate element 24 intended to obtain the first portion 6a and the second portion 6b of the tread band 6.

In such a delivery position, the robotized arm 21 rotates the drum 18 about its rotation axis X-X and carries out a relative displacement between the delivery member 22 and the drum 18 by also imparting to the latter a translational movement along a direction substantially parallel to the aforementioned rotation axis X-X.

Concurrently with the rotation and translation movement of the drum 18, the delivery member 22 delivers the elongate element 24 at a radially outer position with respect to the belt layer 5 as disclosed, for instance, in the European patent EP-928,680 or in the patent application WO 03/070454 in the name of the same Applicant.

The rotation and translation movement of the drum 18 is suitably driven in such a way as to carry out the deposition of at least one continuous elongate element to form a plurality of coils or windings, which are axially overlapped and/or radially superimposed so as to define the portions 6a, 6b of tread band 6.

In more details, according to a preferred embodiment of the present invention, the erogation and subsequent winding of the continuous elongate element 24 is started at point A, which corresponds to the axially outer and radially inner position of the first portion 6a. The latter is then completed at point B, which corresponds to the axially outer and radially outer position of the first portion 6a.

According to the present invention, at the end of the formation of the portion 6a, the erogation of the continuous elongate element 24 is not interrupted and the erogating device, i.e. the delivery member 22, is located in correspondence of the position in which the winding of the continuous elongate element 24 starts forming the portion 6b.

According to the embodiment shown in FIG. 1, the supporting device, i.e. the drum 18, is translated at point C, which corresponds to the axially outer and radially inner position of the second portion 6b, wherein the formation thereof is started. Successively, the erogation and winding of the continuous elongate element 24 is interrupted at point D, which corresponds to the axially outer and radially outer position of the second portion 6b, wherein the formation thereof is completed.

Alternatively, the erogation and subsequent winding of the continuous elongate element 24 is started at point A′, which corresponds to the axially inner and radially inner position of the first portion 6a. The latter is then completed at point B′, which corresponds to the axially inner and radially outer position of the first portion 6a.

Successively, at the end of the formation of the portion 6a, the erogation of the continuous elongate element 24 is not interrupted and the supporting device, i.e. the drum 18, is translated at point C′, which corresponds to the axially inner and radially inner position of the second portion 6b, wherein the formation thereof is started.

Thus, the erogation and winding of the continuous elongate element 24 is interrupted at point D′, which corresponds to the axially inner and radially outer position of the second portion 6b, wherein the formation thereof is completed.

According to said embodiment, the delivery member 22 is stationary and the relative movement between the delivery member 22 and the crude tyre is obtained by imparting a roto-translational movement to the supporting device.

Preferably, the translation of the supporting device is obtained by varying the rotational speed thereof. More preferably, the translation of the supporting device is obtained by increasing the rotational speed thereof.

At the end of the deposition step of said first portion 6a and second portion 6b of the tread band 6, the robotized arm 21 positions the drum 18 at a second delivery position defined at a second delivery member 25 of an extruder 26. The second delivery member 25 supplies the further continuous elongate element 27 which is made of the second elastomeric material intended to form the third portion 6c of the tread band 6.

As in the case of the formation of the first and second portions 6a, 6b, the robotized arm 21 rotates the auxiliary drum 18 about its rotation axis X-X and carries out a relative displacement between the delivery member. 25 and the auxiliary drum 18 also imparting to the latter a translational movement along a direction substantially parallel to the aforementioned rotation axis X-X.

Concurrently with the rotation and translation movement of the auxiliary drum 18, the second delivery member 25 delivers the elongate element 27 in the space comprised between the first portion 6a and the second portion 6b so as to complete the tread band 6.

Also in this case, the delivery of the elongate element 27 is carried out by forming a plurality of coils axially arranged side-by-side and/or radially superposed.

Alternatively (said embodiment being not shown), at the end of the tread band deposition step, the robotized arm 21 discharges the drum 18—supporting the crude tyre—on a conveyor means. Successively, a rotating transferring apparatus, e.g. a manipulator, takes the drum 18 from the conveyor means and positions the drum 18 in proximity of the second delivery member 25 as mentioned above.

At the end of the formation of the tread band, the manufacturing process according to the present invention can comprise the step of storing the finished crude tyre before the moulding and curing steps are performed.

Alternatively, at the end of the formation of the tread band, the crude tyre supported on the drum 18 is transported—in a way known per se and not shown in the figures—to the subsequent work stations of the plant, e.g. the moulding and curing work stations.

According to a variant of the previous embodiment of the process of the present invention, said embodiment being shown in FIG. 3, a substantially cylindrical auxiliary drum 18′ is used on which the belt structure 5 is assembled. The auxiliary drum 18′ is moved substantially in the same way as the drum 18 previously illustrated.

More precisely, the auxiliary drum 18′ is positioned in proximity of the delivery member 22 of an extruder 23. Subsequently, an elongate element 24 of a first elastomeric material is delivered by the delivery member 22 onto the belt structure 5, preferably carrying out a relative displacement between the delivery member 22 and the auxiliary drum 18′ so as to form the first portion 6a and the second portion 6b of the tread band 6 as disclosed above.

Subsequently, the auxiliary drum 18′ is positioned in proximity of the second delivery member 25 of the second elastomeric material, and an elongate element 27 delivered by the member 25 is deposited between the first portion 6a and the second portion 6b, preferably carrying out a relative displacement between the second delivery member 25 and the auxiliary drum 18′ so as to form the third portion 6c of the tread band 6.

Also in this embodiment, the steps of delivering the aforementioned elongate elements 24, 27 of elastomeric material are preferably carried out by rotating the auxiliary drum 18′ about its rotation axis.

Similarly, the aforementioned delivering steps are carried out by forming a plurality of coils axially arranged side-by-side and/or radially superposed so as to define the portions 6a, 6b and 6c of the tread-band 6.

Preferably, finally, the relative displacement between the delivery members 22 and 25 and the auxiliary drum 18′ is carried out by imparting to the auxiliary drum 18′ a translational movement in a direction substantially parallel to its rotation axis.

Preferably, said translational movement is caused by the robotized arm 21 which holds the auxiliary drum 18′. Alternatively (not shown), the auxiliary drum 18′ is hold by a supporting structure which moves the auxiliary drum 18′ in proximity of the delivery members 22 and 25.

At the end of the deposition of the tread band 6, the belt structure-tread band assembly is associated to the remaining components of the tyre which have been manufactured on a different manufacturing drum. Therefore, the final assembling of the crude tyre and the subsequent shaping thereof allow to obtain the finished crude tyre which is suitable for being moulded and cured.

These preferred embodiments (shown in FIGS. 2 and 3) of the process according to the invention have an advantageous and effective application when it is desired to exploit a conventional production line, making use of at least one manufacturing drum on which the semi-finished products, which shall constitute the pneumatic tyre, are at least partially formed, said conventional production line being integrated with a final robotized work station for manufacturing the tread band.

In the embodiment illustrated in FIG. 4, a work station intended to manufacture the tread band 6 of the pneumatic tyre 1 is generally indicated with reference sign 17.

The work station 17 is associated to a highly automated plant for manufacturing pneumatic tyres, or for carrying out part of the working operations foreseen in the production cycle of the pneumatic tyres, said plant being not illustrated in details. Further details on such a manufacturing process are, for example, described in the European patent EP-928,680 mentioned above.

According to said process, the manufacturing of the different structural components of the pneumatic tyre 1 are carried out directly on a support 28, substantially toroidal and preferably substantially rigid, having an outer surface 28a, 28b which is substantially shaped according to the inner configuration of the pneumatic tyre.

Within such a plant, robotized work stations (not shown in FIG. 4) are also present for manufacturing on the toroidal support 28 the carcass structure 2 comprising the annular reinforcing structure 3 and for the subsequent formation of the belt structure 5, at a radially outer position with respect to the carcass structure 2.

The work station 17 comprises a robotized arm known per se, generally indicated with reference sign 29 and preferably of the anthropomorphic type with seven axes, intended to pick up each support 28 carrying the carcass structure 2, the annular reinforcing structure 3 and the belt structure 5 from a pick up position 30, defined at the end of two supporting arms 36, 37 of a trestle 31 or any other suitable supporting means, to a delivery position of the tread band portions.

More specifically, the delivery position of the tread band 6 is defined at a delivery member 32 of an extruder 33 which provides for at least one continuous elongate element (not shown in FIG. 4) for obtaining the first portion 6a and the second portion 6b of the tread band 6.

Further structural and functional details of the robotized arm 29 are described, for example, in the International patent application WO 00/35666 in the name of the same Applicant.

With reference to the work station 17 described above and to FIG. 4, the further preferred embodiment of the process for manufacturing a pneumatic tyre in accordance with the present invention is described herein below.

In details, said process comprises a plurality of preliminary steps which are carried out upstream of the work station 17 by means of a plurality of robotized stations, the latter providing for the manufacturing of the carcass structure 2, the annular reinforcing structure 3 and the belt structure 5 which are successively transported—supported on the toroidal support 28—to the pick up position 30.

In a subsequent step, the robotized arm 29 positions the toroidal support 28 in proximity of the delivery position defined at the delivery member 32 which provides for the continuous elongate element made of the first elastomeric material intended to form the first portion 6a and the second portion 6b of the tread band 6.

In such a delivery position, the robotized arm 29 rotates the support 28 about its rotation axis X-X and carries out a relative displacement between the delivery member 32 and the support 28 also imparting to the latter a translational movement along a direction substantially parallel to the aforementioned rotation axis X-X, as disclosed with reference to the processes shown in FIGS. 2 and 3.

Simultaneously with the rotation and translation movement of the support 28, the delivery member 32 delivers—by means of the extrusion 33—the continuous elongate element at a radially outer position with respect to the belt layer 5 so as to form the two tread band portions 6a, 6b.

Preferably, the delivery of the elongate element is carried out by forming a plurality of coils axially arranged side-by-side and/or radially superposed so as to define said tread band portions.

In a subsequent step, according to the steps sequence described with reference to the embodiments of FIGS. 2 and 3, the robotized arm 29 positions the toroidal support 28 in proximity of a second delivery position defined at a second delivery member 34 of an extruder 35, the latter being adapted to provide at least a second continuous elongate element (not visible in FIG. 4) made of a second elastomeric material.

In this second delivery position, the robotized arm 29 rotates the toroidal support 28 about its rotation axis X-X and carries out a relative displacement between the delivery member 34 and the toroidal support 28 also imparting to the latter a translational movement along a direction substantially parallel to the aforementioned rotation axis X-X.

Simultaneously with the rotation and translation movement of the toroidal support 28, the second delivery member 34 delivers the elongate element on the space comprised between the first portion 6a and the second portion 6b so as to form the third portion 6c of the tread band 6.

Also in this case, the delivery of the elongated element is preferably carried out by forming a plurality of coils axially arranged side-by-side and/or radially superposed.

At the end of the tread band deposition step, the crude tyre is completed by transporting the support 28 to the subsequent work stations of the plant, e.g. the moulding and curing work stations.

This different preferred embodiment (shown in FIG. 4) of the process according to the invention has, in particular, an advantageous and effective application when it is desired to use production techniques which allow to minimize, or possibly eliminate, the production and storage of the semi-finished products, for example by adopting process solutions which allow to make the individual components by directly applying them on the pneumatic tyre being manufactured according to a predetermined sequence by means of a plurality of robotized work stations.

As disclosed above, the process of the present invention is particularly advantageous for the manufacturing of an antistatic tyre 50 schematically shown in FIG. 5.

For simplicity of description, in the appended drawings, same reference signs correspond to similar or identical components.

Antistatic tyre 50 has a tread band 6 which comprises an electrically conductive insert 6c which radially extends from the belt structure 5 to a ground contact surface of the tyre, i.e. said insert radially extends for the whole thickness of the tyre tread band 6.

In details, the tread band 6 of the tyre 50 comprises two portions 6a, 6b, which are made of a first elastomeric material and are axially separate apart from each other, and a third portion 6c, which is interposed between said first and second portions 6a, 6b and is made of a second elastomeric material different from the first elastomeric material. The first elastomeric material is electrically insulative while the second elastomeric material is electrically conductive.

According to a first embodiment of the present invention, the manufacturing process comprises the step of forming the first portion 6a and the second portion 6b of the tyre tread band 6 without interrupting the erogation and the winding of a continuous elongate element made of the first elastomeric material, as disclosed above with reference to any of the processes described in FIGS. 2 to 4. Successively, the tyre manufacturing process comprises the step of forming the tread band third portion 6c by erogating and winding a further continuous elongate element made of the second elastomeric material in the gap comprised between the first portion 6a and the second portion 6b.

Alternatively, according to a further embodiment of the present invention, the manufacturing process comprises the step of previously forming the tread band third portion 6c by erogating and winding a further continuous elongate element made of the second elastomeric material. Successively, the tyre manufacturing process comprises the step of forming the first portion 6a and the second portion 6b of the tyre tread band 6 without interrupting the erogation and the winding of a continuous elongate element made of the first elastomeric material.

According to said embodiment, since the first and second portions 6a, 6b are formed when the electrically conductive third portion 6c is already formed, it is necessary that the winding of the continuous elongate element is carried out by ensuring that only a limited area of the circumferentially extended third portion 6c is overlapped by the continuous elongate element made of the first elastomeric material during the winding thereof. In fact, in order to ensure that the antistatic tyre suitably performs the discharging of the electrostatic charges, at least a portion of the electrically conductive elastomeric material of the third portion has to contact the ground during the tyre revolution.

Said objective can be achieved, for instance, by providing that the winding direction of the continuous elongate element made of the first elastomeric material lies in a radial plane which is inclined of an angle comprised from about 5° to about 85° with respect to the tyre equatorial plane, more preferably from about 30° to 60°. It has to be noted that, generally, the value of said angle depends on the length (in the longitudinal direction) of the tyre footprint (and thus on the tyre size), on the width of the elongate element and on the width of the electrically conductive third portion 6c.

Alternatively, said objective can be achieved, for instance, by remarkably increasing the rotational speed of the supporting device while keeping constant the erogation speed of the continuous elongate element. In such a manner, in fact, as mentioned above, the elongate element is subjected to a stretching action which reduces the cross-section area thereof, thereby reducing the overlapping of the elongate element (which is made of the electrically insulative first elastomeric material) with the already formed third portion (which is made of the electrically conductive second elastomeric material). Thus a suitable discharge of the electrostatic charges is obtained by ensuring that, during the tyre revolution, a sufficient amount of the electrically conductive elastomeric material is present in the tyre footprint area.

Preferably, the antistatic tyre 50 is further provided with a layer 51 which is made of the same electrically conductive elastomeric material of the conductive insert 6c, said layer being interposed between the belt structure 5 and the tread band 6 so that the conductive insert 6c is in electrical and physical contact with said layer 51.

According to a preferred embodiment of the present invention, the tyre manufacturing process comprises the step of forming the layer 51 and the third portion 6c (i.e. the electrically conductive insert)—which are all made of the same second elastomeric material—before the step of forming the first and second portions 6a, 6b of the tread band 6.

In details, according to a preferred embodiment, the step of forming the layer 51 and the third portion 6c comprises the step of forming a first portion 51b of the layer 51, for instance the layer portion which comes into contact with the second portion 6b of the tread band. When said first portion 51b of the layer 51 is completed, the erogation and winding of the further continuous elongate element is interrupted and the supporting device is translated so that the erogating device is placed in correspondence of the position where the second portion 51a of the layer 51 has to be started. Therefore, the second portion Sa of the layer 51 is completed and the formation of the third portion 6c of the tread band is executed in proximity of the axially inner edge of the second portion 51a.

The manufacturing process of the present invention is also particularly advantageous for carrying out the formation of elastomeric inserts which can be provided to the tyre structure.

For instance, FIG. 6 shows a partial cross section of a truck tyre 60 which comprises a carcass structure 61, a belt structure 62 which extends circumferentially around said carcass structure 61, a tread band 63 which is applied in a position radially external to said belt structure 62 and two sidewalls 64 which are laterally applied on opposite sides of the carcass structure 61 and extend from a lateral edge 63a of the tread band 63 in proximity of a radially inner edge of the carcass structure 61.

The carcass structure comprises two beads 65 which include, respectively, a bead core 66 and an elastomeric filler 67 in a position radially external to said bead core 66.

The tyre 60 further comprises at least two inserts 68 (only one being shown in FIG. 6) which are interposed between the carcass structure 61 and the belt structure 62, each insert being located in proximity of the axially opposite edges 62a of the belt structure 62.

In details, each insert 68 comprises an axially inner portion 68a, which is interposed between the carcass ply 69 and the belt structure 62 and is tapered towards the equatorial plane π-π of the tyre, and an axially outer portion 68b, which is interposed between the carcass ply 69 and the correspondent sidewall 64 and is tapered towards the rotational axis of the tyre.

According to the embodiment shown in FIG. 7 the belt structure 62 comprises two belt layers 62a, 62b which are radially superposed and comprise reinforcing cords, usually of metal material, that are disposed parallel to each other in each layer and in crossed relationship with the cords of the adjacent layer, preferably symmetrically disposed with respect to the equatorial plane π-π of the tyre.

Furthermore, the belt structure 62 comprises two belt strips 62c which are disposed in a radially outer position of said belt layers 62a, 62b and at each axially outer edges thereof, said belt strips 62c being reinforced with cords which are oriented in a substantially circumferential direction.

Moreover, the belt structure 62 comprises a further belt layer 62d which is radially external to the belt layers 62a, 62b and is interposed between the belt strips 62c. Said further belt layer 62d is provided with cords that are inclined with respect to a circumferential direction, said belt layer acting as a protection layer from stones or gravel possibly entrapped into the tread grooves and which can cause damages to the belt layers 62a, 62b and even to the carcass ply 69.

As mentioned above, the inserts 68 of the tyre 60 can be advantageously manufactured in one step according to the process of the present invention.

According to a further embodiment, the manufacturing process of the present invention can comprise the step of forming the inserts 71, 72 of a truck tyre 70 shown in FIG. 7.

The inserts 71, 72 are part of the tread band 63 and are located in correspondence of the buttress areas, i.e. the areas where the axially opposite edges of the tread band are joined to the respective sidewalls of the tyre. Usually, the inserts 71, 72 are interposed between the carcass structure, the belt structure, the tread band and the sidewalls.

In details, each insert 71, 72 comprises an axially inner portion 71a, 72a, which is interposed between the belt structure 62 and the tread band 63 and is tapered towards the equatorial plane π-π of the tyre, and an axially outer portion 71b, 72b, which is interposed between the carcass ply 69 and the correspondent sidewall 64 and is tapered towards the rotational axis of the tyre.

As mentioned above, the inserts 71, 72 of the tyre 70 can be advantageously manufactured in one step according to the process of the present invention.

1-39. (canceled)

40. A process for manufacturing a tyre comprising:
forming a crude tyre on a supporting device, and moulding and curing said crude tyre, wherein the step of forming the crude tyre comprises providing at least one structural element comprising:
at least one first portion made from a first crude elastomeric material, and
at least one second portion made from said first crude elastomeric material, the at least one second portion being axially spaced apart from the at least one first portion,
said step of providing the at least one structural element comprising:
forming the at least one first portion by winding at least one continuous elongate element made from said first crude elastomeric material by means of a roto-translational movement between the supporting device and at least one erogating device for supplying the at least one continuous elongate element;
starting to apply the continuous elongate element in a position axially spaced apart from the at least one first portion while continuing supplying the at least one continuous elongate element so as to form the at least one second portion; and
forming the at least one second portion by winding said at least one continuous elongate element made from said first crude elastomeric material by means of a roto-translational movement between the supporting device and the at least one erogating device.

41. The process according to claim 40, wherein said at least one structural element comprises at least one third portion made of a second crude elastomeric material different from said first elastomeric material, said process further comprising the step of forming the at least one third portion by winding at least one further continuous elongate element made from said second crude elastomeric material by means of a roto-translational movement between the supporting device and at least one further erogating device for supplying the at least one further continuous elongate element.

42. The process according to claim 41, wherein said third portion is interposed between the at least one first portion and the at least one second portion.

43. The process according to claim 41, wherein the step of forming the at least one third portion is carried out before the step of forming the at least one first portion.

44. The process according to claim 41, wherein the step of forming the at least one third portion is carried out after the step of forming the at least one first portion and the step of forming the at least one second portion.

45. The process according to claim 40, wherein said roto-translational movement results from a relative rotational speed combined with a relative translational speed.

46. The process according to claim 45, further comprising the step of increasing the relative rotational speed while continuing supplying the at least one continuous elongate element at the end of the step of providing said at least one first portion.

47. The process according to claim 45, further comprising the step of increasing the relative translational speed while continuing supplying the at least one continuous elongate element at the end of the step of providing said at least one first portion.

48. The process according to claim 40, further comprising the step of providing a crude carcass structure by assembling at least one carcass ply with at least two annular reinforcing structures.

49. The process according to claim 48, further comprising the step of providing a belt structure in a position radially external to said carcass structure.

50. The process according to claim 40, wherein the step of winding comprises the step of forming a plurality of coils axially arranged side-by-side and/or radially superposed.

51. The process according to claim 48, wherein the step of providing the carcass structure is carried out on the supporting device.

52. The process according to claim 49, wherein the step of providing the belt structure is carried out on the supporting device.

53. The process according to claim 51, further comprising the step of positioning said supporting device in proximity of the erogating device.

54. The process according to claim 51, further comprising the step of positioning the erogating device in proximity of said supporting device.

55. The process according to claim 53, further comprising the step of delivering the at least one elongate element by means of said erogating device.

56. The process according to claim 55, wherein the step of delivering the at least one elongate element is performed while carrying out a relative displacement between the erogating device and the supporting device.

57. The process according to claim 56, wherein the step of delivering the at least one elongate element is performed while rotating the supporting device about its rotation axis.

58. The process according to claim 57, wherein the relative displacement between the erogating device and the supporting device is carried out by imparting to the supporting device a translational movement along a direction substantially parallel to its rotation axis.

59. The process according to claim 40, wherein said position corresponds to the axially outer and radially inner position of said second portion.

60. The process according to claim 59, wherein the step of forming said second portion is carried out by completing the winding of said continuous elongate element at an axially outer and radially outer position of said second portion.

61. The process according to claim 40, wherein the step of forming said first portion is carried out by starting the winding of said continuous elongate element at an axially outer and radially inner position of said first portion.

62. The process according to claim 61, wherein the step of forming said first portion is carried out by completing the winding of said continuous elongate element at an axially outer and radially outer position of said first portion.

63. The process according to claim 49, further comprising the step of providing at least one layer in a position radially external to said belt structure, said layer being made of an electrically conductive elastomeric material.

64. The process according to claim 41, wherein said at least one third portion radially extends from said electrically conductive layer to a ground contact surface of the tyre.

65. The process according to claim 64, wherein said electrically conductive layer is obtained by winding said at least one further elongate element.

66. The process according to claim 65, wherein the step of winding the at least one further elongate element further comprises the steps of:
forming a first portion of said at least one electrically conductive layer by axially arranging side-by-side and/or radially superposing a plurality of coils of said at least one further elongate element;
forming a second portion of said at least one electrically conductive layer by axially arranging side-by-side and/or radially superposing a plurality of coils of said at least one further elongate element; and
forming said third portion by axially arranging side-by-side and/or radially superposing a plurality of coils of said at least one further elongate element.

67. The process according to claim 51, wherein the supporting device consists of a manufacturing drum, an auxiliary drum or a toroidal support.

68. The process according to claim 48, wherein the step of providing the carcass structure comprises the steps of producing and assembling the carcass structure on a toroidal support.

69. The process according to claim 49, wherein the step of providing the belt structure comprises the steps of producing and assembling the belt structure on a toroidal support.

70. The process according to claim 67, wherein the toroidal support is substantially rigid.

71. The process according to claim 40, wherein a winding direction of the continuous elongate element made of the first elastomeric material lies in a radial plane which is inclined at an angle of about 5° to about 85° with respect to the tyre equatorial plane.

72. The process according to claim 40, wherein said at least one structural element is a tread band.

73. The process according to claim 40, wherein said first elastomeric material is an electrically insulative material.

74. The process according to claim 41, wherein said second elastomeric material is an electrically conductive material.

75. The process according to claim 40, wherein said at least one structural element is a liner.

76. The process according to claim 40, wherein said at least one structural element is an elastomeric insert which is located under the belt structure at the axially outer edges thereof.

77. The process according to claim 40, wherein said at least one structural element is an elastomeric insert which is located between the axially outer edges of the belt structure and the tread band.

78. The process according to claim 40, wherein said at least one structural element is an elastomeric insert which is located in a tyre sidewall.
